(19) United States
(12) Patent Application Publication
(10) Pub. No.: US 2025/0316283 A1
(43) Pub. Date: Oct. 9, 2025

(54) Quality Score Predictor for Transcoded Data

(71) Applicant: T-Mobile Innovations LLC, Overland Park, KS (US)

(72) Inventor: Do Kyu LEE, Mercer Island, WA (US)

(21) Appl. No.: 18/627,208

(22) Filed: Apr. 4, 2024

(51) Int. Cl. G10L 19/16; G10L 25/60; G10L 25/69; H04L 65/1104

(52) U.S. Cl. CPC G10L 19/173; G10L 25/60; G10L 25/69; H04L 65/1104

(57) ABSTRACT

Methods, systems, and apparatus, including computer programs encoded on a computer storage medium, for predicting a quality score for transcoded data are disclosed. In one aspect, a method includes the actions of receiving, from an originating device, a request to initiate an audio communication with a terminating device. The actions further include providing, for output, an indication that the originating device is configured to process the given audio data using a first codec and a second codec. The actions further include receiving data indicating a selection of the first codec. The actions further include determining that audio data received or to be received is transcoded from the second codec or another codec. The actions further include determining a likely MOS of audio output by the originating device from processing the transcoded audio data. The actions further include determining an action that is configured to increase the MOS of the audio.

### CROSS-REFERENCE TO RELATED APPLICATIONS

None.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Transcoding is the direct digital-to-digital conversion of one encoding to another, such as for video data files or audio files. Transcoding is usually done in cases where a target device does not support the encoding format. Transcoding may be a lossy process because information may be lost when converting from one encoding to another.

### SUMMARY

An innovative aspect of the subject matter described in this specification may be implemented in methods that include the actions of receiving, by an application and from an originating device, a request to initiate an audio communication with a terminating device; determining, by the application, that the originating device is configured to process given audio data using a first codec and a second codec; providing, for output by the application via a first session initiation protocol (SIP) session description protocol (SDP) message, an indication that the originating device is configured to process the given audio data using a first codec and a second codec; receiving, by the application via a second SIP SDP message, data indicating a selection of the first codec; determining, by the application, that audio data received or to be received is transcoded from the second codec or another codec; based on determining that the audio data received or to be received is transcoded from the second codec or the other codec, determining, by the application, a likely mean opinion score (MOS) of audio output by the originating device from processing the transcoded audio data; and based on the likely MOS of the audio output by the originating device from processing the transcoded audio data, determining, by the application, an action that is configured to increase the MOS of the audio.

Another innovative aspect of the subject matter described in this specification may be implemented in methods that include the actions of receiving, from an originating device, a request to initiate an audio communication with a terminating device; determining that the originating device is configured to process given audio data using a first codec and a second codec; providing, for output, an indication that the originating device is configured to process the given audio data using a first codec and a second codec; receiving data indicating a selection of the first codec; providing, for output, a first session initiation protocol, session description protocol negotiation message; in response to providing, for output, the session initiation protocol, session description protocol negotiation message, receiving data indicating the audio data received or to be received is transcoded from the second codec or another codec; based on receiving the data indicating that the audio data received or to be received is transcoded from the second codec or another codec, determining a likely mean opinion score (MOS) of audio output by the originating device from processing the transcoded audio data; and based on the likely MOS of the audio output by the originating device from processing the transcoded audio data, determining an action that is configured to increase the MOS of the audio

Another innovative aspect of the subject matter described in this specification may be implemented in methods that include the actions of receiving, from an originating device, a request to initiate an audio communication with a terminating device; determining that the originating device is configured to process given audio data using a first codec and a second codec; providing, for output, an indication that the originating device is configured to process the given audio data using a first codec and a second codec; receiving data indicating a selection of the first codec; determining that the data indicating the selection of the first codec includes a flag indicating that audio data received or to be received is transcoded from the second codec or another codec; based the data indicating the selection of the first codec includes the flag indicating that audio data received or to be received is transcoded from the second codec or the other codec, determining that audio data received or to be received is transcoded from the second codec or the other codec; based on determining that the audio data received or to be received is transcoded from the second codec or the other codec, determining a likely mean opinion score (MOS) of audio output by the originating device from processing the transcoded audio data; and based on the likely MOS of the audio output by the originating device from processing the transcoded audio data, determining an action that is configured to increase the MOS of the audio.

Other implementations of these aspects include corresponding systems, apparatus, and computer programs recorded on computer storage devices, each configured to perform the operations of each method.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 illustrates an example system that is configured to determine when an audio communication includes transcoded audio data and, if necessary, perform an action to improve audio quality.

FIG. 2 illustrates an example server that is configured to train models that are configured to predict a mean opinion score (MOS) for transcoded audio.

FIG. 3 is a flowchart of an example process for determining when an audio communication includes transcoded audio data and, if necessary, perform an action to improve audio quality.

FIG. 4 illustrates an example computer system.

### DETAILED DESCRIPTION

It should be understood at the outset that although illustrative implementations of one or more implementations are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

During a telephone call between two people, the voices of each person is detected by a microphone, converted to a digital signal, filtered, and encoded. This process reduces the amount of information that has to be exchanged between the phones of each person while attempting to preserve the audio quality. In a typical scenario, the phones of the two people are configured to use a similar process to process the speech. By using a similar process, each phone can reconstruct the received audio data to prepare for output to an audio speaker.

In some instances, the two phones may not be configured to use a similar process to process and reconstruct the speech. This difference may occur in how the digital speech data is encoded. Different phones may use different encoding schemes. When this happens, one of the phones may transcode the encoded data. Transcoding can introduce some undesirable characteristics that may reduce the quality of the audio output by the receiving device.

For example, in the case of adaptive multi-rate wide band (AMR-WB) and enhanced voice service (EVS) super wideband that may be used in 4G and 5G communications, EVS super wideband has a transcoding, or up-sampling feature, that includes recovery logic to regenerate packets on the server side. This transcoding, or up-sampling feature of EVS super wideband has some shortcomings. The regenerated packets may not be the same packet as the original packet from the sending device. This may cause a drop in the mean opinion score (MOS). The MOS is a number that reflects the quality of a frame of audio or video. In some instances, packet loss and jitter are some of the factors used to determine the MOS. The drop in the MOS may be reflected in a drop in the quality of the call from the perception of the user of the receiving device.

Whether audio data will be transcoded or not may not be readily determined by the receiving device. In some instances, the receiving device can query the sending device as to whether the audio data will be transcoded. In some instances, the sending device can provide a notification that the audio data will be transcoded. With the transcoding information, the receiving device can use models trained using machine learning to analyze various aspects of the communication, including whether the audio data will be transcoded, to determine a likely mean opinion score (MOS) that represents the quality of the audio output by the device receiving the transcoded data.

With the likely MOS of the audio output by the device receiving the transcoded data, the receiving device can take various actions in an attempt to improve the audio quality. In some instances, the receiving device can negotiate a new encoding scheme with the other device that both devices support in order to avoid transcoded data. In some instances, the receiving device may indicate the possible reduction in quality to the user. The user may indicate whether to proceed with the phone call.

In more detail, the data from a device with a real-time transport protocol (RTP) downlink or uplink in the telephony application server-side detection of RTP packet loss can be gathered by divided classification involving real EVS to EVS and/or EVS-transcoded data from/to AMR of another device that may be associated with a different mobile network operator. In this case, one party can retrieve the other party's codec information via a session initiation protocol (SIP) session description protocol (SDP) message. This information may be used for Random Forest modeling and k-means cluster machine learning model. In some instances, accuracy and precision of the model may be illustrated using a sum of square confidence matrix to show an exponential decayed math slope to match an MOS model graph. The model may be used to predict the expected MOS score for each codec EVS, transcoded EVS (from AMR).

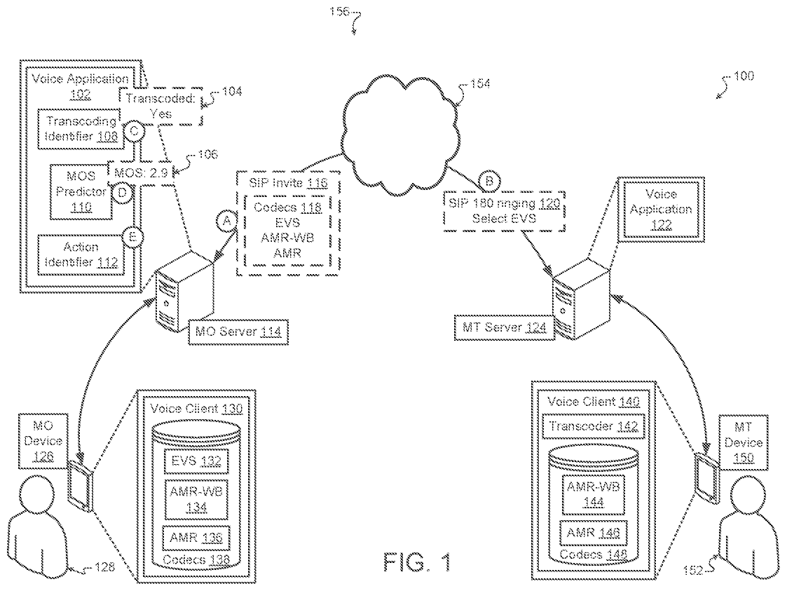

FIG. 1 illustrates an example system 100 that is configured to determine when an audio communication includes transcoded audio data and, if necessary, perform an action to improve audio quality. Briefly, and as described in more detail below, the user 128 is attempting to initiate a voice conversation with the user 152. The user 128 is using the mobile originating (MO) device 126. The user 152 is using the mobile terminating device (MT) device 150. The MO server 114 may determine whether the audio received or to be received from the MT device 150 is transcoded and whether this will compromise the audio quality experienced by the user 128. Based on that determination, the MO server 114 or another component of the system 100 may take an action to improve the audio quality. FIG. 1 includes various stages A through E that may illustrate the performance of actions and/or the movement of data between various components of the system 100. The system 100 may perform these stages in any order.

In more detail, the user 128 may be interacting with the MO device 126. The MO device 126 may be referred to as the mobile originating device because the user 128 may be attempting to initiate a voice communication with the user 152. The user 152 may be interacting with the MT device 150. The MT device 150 may be referred to as the mobile terminating device because the user 152 is receiving a request to initiate the voice communication. The MO device 126 and the MT device 150 may be different types of devices and may be any type of device that is configured to communication with other computing device. For example, the MO device 126 and the MT device 150 may each be a mobile phone, laptop computer, desktop computer, tablet, smart watch, server, and/or any other similar type of device.

The MO device 126 and the MT device 150 may each communicate through their respective servers. The MO device 126 may communicate through the MO server 114. The MT device 150 may communicate through the MT server 124. The MO device 126 may communicate with the MO server 114 through any type of network such as the network of a wireless service provider, the internet, and/or any other similar type of network. Similarly, the MT device 150 may communicate with the MT server 124 through any type of network such as the network of a wireless service provider, the internet, and/or any other similar type of network. The network that the MT device 150 and the MT server 124 communicate over may be the same network or a different network than the network that the MO device 126 and the MO server 114 communicate.

In some implementations, the network that the MO device 126 and the MO server 114 and/or the MT device 150 and the MT server 124 may use to communicate may change. The network may change based on the location of the MO device 126 and/or the MT device 150 and/or based on whether the MO device 126 and/or the MT device 150 are within range of a preferred network such as a Wi-Fi network. In some implementations, the MO server 114 and the MT server 124 may be the same device. In other words, the MO device 126 and the MT device 150 may be communicating with the same server, which may be over the same network or a different network.

The MO server 114 and the MT server 124 may be any type of device that is capable of communicating with other devices. For example, the MO server 114 and the MT server 124 may be a mobile phone, laptop computer, desktop computer, tablet, smart watch, server, and/or any other similar type of device. The MO server 114 and the MT server 124 may communicate with each other over the network 154. The network 154 may be the same network as either of the networks that the MO device 126 and the MO server 114 or the MT device 150 and the MT server 124 are using to communicate or a different network.

The MO device 126 may include a voice client 130. The voice client 130 may be an application running on the MO device 126 that is capable of initiating and receiving audio communications, such as voice communications. For example, the voice client 130 may be a telephone application, a messaging application with an audio communication functionality, a video chat application with an audio communication functionality, and/or any other similar type of application. The voice client 130 may be configured to receive the audio detected by the microphone of the MO device 126, process the audio, and provide the audio to a communication interface that communicates with the MO server 114.

As part of the processing of the audio, the voice client 130 uses codecs 138. A codec is a device or application that encodes and/or decodes a data stream or signal. The term codec is a combination of coder and decoder. In the example of FIG. 1, the voice client 130 use codecs to convert a digital stream of audio data into another digital stream that may be a compressed version of the original digital stream. The compressed version of the original stream may require less network resources to transmit compared to transmitting a stream of digital samples of audio detected by the microphone. Some codecs may be lossless and others may be lossy. The lossless codecs may compress the original stream without any loss of information. The original stream may be reconstructed from the compressed stream. The lossy codecs may compress the original stream with some loss of information. The original stream may be estimated from the compressed stream. In an ideal scenario, the user listening to the estimated stream may detect little to no difference in the audio of the estimated stream compared to the original stream.

There may be different types of codecs 138 available to the voice client 130. For example, the codecs 138 may include the enhanced voice service (EVS) codec 132, the adaptive multi-rate wide band (AMR-WB) codec 134, the adaptive multi-rate (AMR) codec 136, and/or any other additional codecs. Each of these codecs may encode the digitized audio signal in a different way. In order to be able to decode the encoded audio stream in a timely manner during an audio communication between users, it may be helpful for the decoding device to receive a communication indicating what codec was used to encode the encoded audio stream. With this information the receiving device may decode the audio stream in an amount of time that will allow the conversation between users to continue to appear to be occurring in real-time to the users with minimal processing delays.

In stage A, the user 128 may interact with the MO device 126. The user 128 may be attempting to place a telephone call to the user 152. The user 128 may interact with the voice client 130 on the interface of the MO device 126. The user 128 may indicate to the voice client 130 to call the user 152. The voice client 130 may provide an indication to the MO server 114 that initiates the communication with the MT device 150.

The voice application 102 of the MO server 114 may be the counterpart application that interacts with the voice client 130 of the MO device 126. The voice application 102 may receive instructions and data from the voice client 130. The voice application 102 may provide instructions and data to the voice client 130. The exchange of instructions and data may occur before, during, and after the user 128 and/or user 152 begin speaking.

The voice application 102 may be configured to generate an initial packet in response to the request to initiate the communication with the MT device 150. In some implementations, this packet may be a session initiation protocol (SIP) invite 116. As part of the SIP invite 116, the voice application 102 may include a codec identifier 118 that indicates the codecs that the MO device 126 and/or the MO server 114 are configured to support. To determine the supported codecs, the MO server 114 may generate and send a request to the MO device 126 requesting information on the codec that the MO device 126 can support. The MO device 126 may respond with an indication that the MO device 126 can support the EVS codec 132, the AMR-WB codec 134, and the AMR codec 136. In some implementations, the MO server 114 may store or have access to information identifying the codecs that the MO device supports 126 without sending a request to the MO device 126.

The voice application 102 may indicate support for the EVS codec 132, the AMR-WB codec 134, and the AMR codec 136 in the codec identifier 118 of the SIP invite 116. The voice application 102 may provide the SIP invite 116 to the MT server 124 over the network 154. The voice application 122 of the MT server 124 may receive the SIP invite 116 and perform the next steps in order to connect the MO device 126 and the MT device 150 over a voice communication.

The MT server 124 may include a voice application 122 that is similar to the voice application 102 of the MO server 114. The MT device 150 may also include a voice client 140 that is similar to the voice client 130 of the MO device 126. The MT server 124 may interact with the MT device 150 in a similar way that the MO server 114 interacts with the MO device 126.

In stage B, the voice application 122 receives and processes the SIP invite 116. The SIP invite 116 identifies the MT device 150 as the device that the MO device 126 intends to communicate with. In response to receiving the codec identifier 118 and the data identifying the MT device 150, the voice application 122 initiates communication with the MT device 150. The voice application 122 requests, from the MT device 150, data indicating the codecs that the voice client 140 supports. The request may also indicate the codecs that the voice client 130 of the MO device 126 supports.

The voice application 122 receives the request for the supported codecs. The voice client 140 accesses the codecs 148. The codecs 148 include the AMR-WB codec 144 and the AMR codec 146. The voice client 140 also includes a transcoder 142. The transcoder 142 may be configured to convert data encoded using one codec to another codec. For example, the user 152 may speak an utterance. The microphone of the MT device 150 detects the utterance, and an analog to digital converter samples the analog data generated by the microphone. The voice client 140 may use the AMR codec 146 to encode the sampled audio data. If the voice client 140 is required to send audio data encoded using a codec that is not included in the codecs 148, then the transcoder 142 converts the encoded audio data into audio data that is encoded using another codec. The resulting encoded audio data is transcoded because the encoded audio data was converted to audio with a different type of encoding. In some implementations, the transcoder 142 may be included in the voice application 122 instead of the voice client 140. The transcoder 142 may be included in the voice application in instances where the voice client does not include the functionality of the transcoder 142. The transcoder 142 may be included in the voice application 122 because the detection of transcoded data and/or decision to transcode information may be confirmed in the voice application 122 before confirming the detection and/or decision with the MO device 126.

In some implementations, transcoding may involve up-sampling. In this case, the audio data encoded using a first codec may not include enough information for the transcoder 142 to generate the transcoded data. The transcoder 142 may include some portions that are estimated and/or duplicates of neighboring portions. The transcoded data may be different and less accurate than if the transcoding codec were used to encode the original sampled data. When the transcoded data is decoded and output to a user, the transcoded data may have lower quality sound than regular encoded data because the up-sampled portions are essentially filler and not encoding actual audio data.

In response to receiving the request for the codecs supported by the voice client 140, the voice client 140 may generate a notification indicating that the codecs 148 include the AMR-WB codec 144 and the AMR codec 146. Because the voice client 140 also includes the transcoder 142, the voice client 140 may include in the notification that the voice client 140 supports additional codecs such as EVS and/or other codecs. In this case, the voice client 140 may provide the notification to the MT server 124 indicating that the voice client 140 supports the AMR-WB codec 144, the AMR codec 146, and the EVS codec.

The voice application 122 receives this notification indicating the codecs supported by the voice client 140. In some implementations, the voice application 122 stores or has other access to data indicating the codecs supported by the voice client 140. In this case, it may not be necessary for the voice application 122 to request the supported codecs from the voice client 140. The voice application 122 compares the codecs supported by the voice client 140 to the codecs included in the SIP invite 116. The voice application 122 may select EVS as the codec for the upcoming voice communication. In some implementations, the voice application 122 may receive data indicating a codec preference for the MO device 126 and/or the MO server 114. If possible, the voice application 122 may select a codec in line with that preference.

The voice application 122 may generate a SIP 180 ringing 120 that includes the codec selection. For example, the codec selection may be the EVS codec. The MT server 124 may provide the SIP 180 ringing 120 to the MO server 114 via the network 154. The voice application 102 may process the SIP 180 ringing 120 in preparation for the start of the voice communication between the user 128 and the user 152.

As part of the processing of the SIP 180 ringing 120, and in stage C, the voice application may use the transcoding identifier 108 to determine whether the encoded voice data to be received from the MT device 150 will be transcoded. In the case of EVS being selected as the codec, the transcoding identifier 108 may determine whether the encoded voice data to be received from the MT device 150 is EVS encoded voice data or EVS transcoded voice data.

In some implementations, the transcoding identifier 108 may generate a SIP session description protocol (SDP) negotiation message that requests information on whether the encoded voice data to be received from the MT device 150 is transcoded or not transcoded. The MO server 114 may provide the SIP SDP negotiation message to the MT server 124.

The voice application 122 may receive the SIP SDP negotiation message that requests information on whether the EVS voice data will be transcoded. The voice application 122 may determine the answer to the transcoding query with or without requesting data from the MT device 150. In some implementations, the voice application 122 may store or have access to data indicating that the codecs 148 include the AMR-WB codec 144 and the AMR codec 146, thus EVS voice data is transcoded. In some implementations, the voice application 122 may generate and provide a request to the MT device 150 for information on whether the EVS voice data will be transcoded. The voice client 140 may provide a response indicating that the EVS voice data is transcoded.

The voice application 122 generates a response to the SIP SDP negotiation message indicating that the EVS voice data is transcoded. The MT server 124 provides this response to the SIP SDP negotiation message to the MO server 114. The transcoding identifier 108 processes the response and generates the transcoding indicator 104 that indicates the voice data received from the MT server 124 is transcoded.

In some implementations, the transcoding identifier 108 may determine whether the voice data received from the MT server 124 will be transcoded based on a flag that is included in the SIP 180 ringing 120 before the 180 ringing or at least within the 180 ringing message. In this case, the voice application 122 may determine whether the EVS voice data received from the MT device 150 will be transcoded. The voice application 122 may make this determination based on accessing the codecs 148 and/or by receiving data from the MT device 150 indicating that the EVS voice data will be transcoded. In this case, the voice application 122 may include a flag in the SIP 180 ringing 120 indicating that the EVS voice data will be transcoded. The flag may also indicate that the voice data will not be transcoded in the event that the voice application 122 makes that determination.

The transcoding identifier 108 analyzes the SIP before the SIP 180 ringing 120 within the provisional response acknowledgement (PRACK) SDP negotiation or the SIP 180 ringing 120 and determines the state of the transcoding flag. Based on the state of the transcoding flag, the transcoding identifier 108 generates the transcoding indicator 104 that indicates whether voice data received from the MT server 124 is transcoded. In some implementations, the SIP 180 ringing 120 may not include a transcoding flag. In this case, the transcoding identifier 108 may request transcoding information from the MT server 124 in response to the SIP 180 ringing 120 not including a transcoding flag.

In stage D and in response to the transcoding identifier 108 generating the transcoding indicator 104 that indicates whether the voice data to be received from the MT server 124 is transcoded, the mean opinion score (MOS) predictor 110 may determine a likely MOS for the transcoded voice data. The MOS may indicate a quality of the audio output by the MO device 126 and generated based on the encoded audio data received from the MT device 150. If the transcoding indicator 104 indicates that the voice data to be received from the MT server 124 is transcoded, then that may initiate the MOS predictor 110 to determine a likely MOS of the voice data to be received from the MT server 124. In some implementations, the MOS predictor 110 may determine a likely MOS of the voice data to be received from the MT server 124 independent of the transcoding indicator 104.

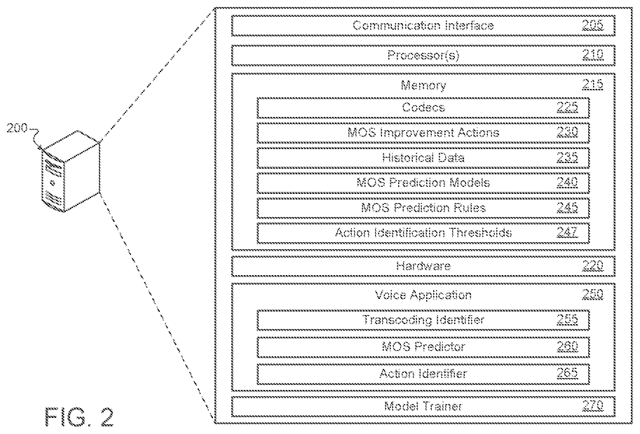

The MOS predictor 110 may be configured to use a machine learning trained model to analyze various factors to determine a likely MOS of the voice data to be received from the MT server 124. The training of the model will be discussed below with respect to FIG. 2. The MOS predictor 110 may provide the factors to the model. The model may be configured to output a likely MOS of the voice data to be received from the MT server 124. The MOS predictor 110 may generate an MOS packet 106 that includes the likely MOS. For example, the model may output a likely MOS of 2.9. In some implementations, the MOS may be in the range of zero to 4.5.

The models used by the MOS predictor 110 may be configured to receive various types of data. In some implementations, the models may be configured to receive the codec information. The codec information may include the original codec used by the voice client 140 of the MT device 150 and the codec used to transcode the audio data. In some implementations, the models may be configured to receive radio frequency information. The radio frequency information may indicate the frequencies that the communications between the MT device 150 and the MT server 124 and/or between the MT server 124 and the MO server 114 and/or between the MO device 126 and the MO server 114. The radio frequency information may also include other parameters related to these communication channels.

In some implementations, the models may be configured to receive real-time transport protocol (RTP) packet information and real-time transport protocol control protocol (RTCP) packet information. The RTP packet information and/or the RTCP packet information may include transmission statistics related to the RTP packets and/or the RTCP packets exchanged between the MT device 150 and the MT server 124 and/or between the MT server 124 and the MO server 114 and/or between the MO device 126 and the MO server 114. In some implementations, the models may be configured to receive loss rate information. The loss rate information may indicate the packet loss rate during communications between the MT device 150 and the MT server 124 and/or between the MT server 124 and the MO server 114 and/or between the MO device 126 and the MO server 114.

In some implementations, the models may be configured to receive jitter information. The jitter information may include the jitter experienced during communications between the MT device 150 and the MT server 124 and/or between the MT server 124 and the MO server 114 and/or between the MO device 126 and the MO server 114.

In stage E, the action identifier 112 of the voice application 102 determines an action for the voice application 102 or another component of the system 100 to take to improve the audio quality experienced by the user 128 of the MO device 126. In some implementations, the action identifier 112 may be configured to compare the MOS to an MOS threshold. If the MOS does not satisfy the MOS threshold, then the action identifier 112 may determine an action to perform to improve the audio quality. In some implementations, the action identifier 112 may select an action based on a difference between the MOS and the MOS threshold. The greater the difference, the more disruptive the action may be.

In some implementations, the action may involve the voice application 102 providing an instruction to the MT server 124 to select a different codec. In this case, the voice application 122 may propose a different codec, and the action identifier 112 may accept the different codec based on the transcoding identifier 108 indicating that the different codec is not transcoded.

In some implementations, the action may involve the voice application 102 providing an instruction to the MO device 126 for the user 128 to disconnect the voice communication and reattempt the voice communication. The instruction may indicate whether the user 128 should use the voice client 130 or another application running on the MO device 126. In some implementations, the instruction may instruct the MO device 126 to perform these reconnection attempts automatically.

In some implementations, the action may involve instructing the voice client 130 to generate a new list of codecs 118 to include in a new SIP invite 116. The new list of codecs 118 will not include the codec that the MT device 150 is transcoding. This action may be performed automatically by the voice application 102. The result of any of these actions should be an improvement in the quality of the voice audio outputted by the MO device 126.

FIG. 2 illustrates an example server 200 that is configured to train models that are configured to predict a mean opinion score (MOS) for transcoded audio. The device 200 may be any type of computing device that is configured to communicate with other computing devices. The device 200 may communicate with other computing devices using a wide area network, a local area network, the internet, a wired connection, a wireless connection, and/or any other type of network or connection. The wireless connections may include Wi-Fi, short-range radio, infrared, and/or any other wireless connection. The device 200 may be similar to the MO server 114 of FIG. 1. Some of the components of the device may be implemented in a single computing device or distributed over multiple computing devices. Some of the components may be in the form of virtual machines or software containers that are hosted in a cloud in communication with disaggregated storage devices.

The server 200 may include a communication interface 205, one or more processors 210, memory 215, and hardware 220. The communication interface 205 may include communication components that enable the server 200 to transmit data and receive data from devices connected to the wireless carrier network. The communication interface 205 may include an interface that is configured to communicate with base stations of a wireless carrier network. The communication interface 205 may receive data that other devices transmit to the base stations and/or transmit data to the base stations for transmission to the other devices. In some implementations, the communication interface 205 may be configured to communicate over a wide area network, a local area network, the internet, a wired connection, a wireless connection, and/or any other type of network or connection. The wireless connections may include Wi-Fi, short-range radio, infrared, and/or any other wireless connection.

The hardware 220 may include additional user interface, data communication, or data storage hardware. For example, the user interfaces may include a data output device (e.g., visual display, audio speakers), and one or more data input devices. The data input devices may include, but are not limited to, combinations of one or more of keypads, keyboards, mouse devices, touch screens that accept gestures, microphones, voice or speech recognition devices, and any other suitable devices.

The memory 215 may be implemented using computer-readable media, such as computer storage media. Computer-readable media includes, at least, two types of computer-readable media, namely computer storage media and communications media. Computer storage media includes volatile and non-volatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD), high-definition multimedia/data storage disks, or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanism. In some implementations, the data stored in the memory 215 may be stored externally from the server 200.

The one or more processors 210 may implement, through the execution of computer-executable instructions, a voice application 250. The voice application 250 may be similar to the voice application 102 of FIG. 1. The voice application 250 may be configured to interact with a voice client of a computing device and with a voice application of another server. The voice application 250 may manage and/or interact with the other server using SIP-based communications and/or any other similar protocol.

In some implementations, the memory 215 may store codecs 225. The codecs 225 may be similar to the codecs 138 stored on the MO device 126 and/or the codecs 148 stored on the MT device 150. In some implementations, the memory 215 may not include any codecs. In this case, the device that detects the audio processes the audio using the codecs. In some implementations, the codecs 225 may include data identifying the codecs available to the device that detects the audio. In this case, the voice application 250 may access the codecs 225 to determine the available codecs instead of communicating with the device that detects the audio.

The voice application 250 may include a transcoding identifier 255. The transcoding identifier 255 may be similar to the transcoding identifier 108 of FIG. 1. The transcoding identifier 255 may be configured to determine whether encoded audio data received or to be received from another server is transcoded. The transcoding identifier 255 may generate a transcoding indicator that indicates whether the audio data received or to be received is or will be transcoded.

The voice application 250 may include an MOS predictor 260. The MOS predictor 260 may be similar to the MOS predictor 110 of FIG. 1. The MOS predictor 260 may be configured to use the MOS prediction models 240 and/or the MOS prediction rules 245 to determine a likely MOS of audio data to be received from another server or computing device. The MOS predictor 260 may provide various characteristics of the voice communication to the MOS prediction models 240 and/or the MOS prediction rules 245. The MOS prediction models 240 and/or the MOS prediction rules 245 may output the likely MOS of the audio data. The MOS predictor 260 may generate an MOS packet that includes the likely MOS of the audio data to be received from another server or computing device.

The voice application 250 may include an action identifier 265. The action identifier 265 may be similar to the action identifier 112 of FIG. 1. The action identifier 265 may be configured to identify an action that is configured to improve the MOS of the audio data to be received by the server 200. The action identifier 265 may compare the MOS to the action identification thresholds 247 to select an action from the MOS improvement actions 230.

The action identification thresholds 247 may include thresholds and/or ranges that each correspond to one or more actions from the MOS improvement actions 230. For example, a range of a likely MOS between 2.0 and 2.5 may correspond to an action of requesting that the transcoding device select a different codec. A range of a likely MOS between 1.5 and 2.0 may correspond to an action of closing the current voice client on the device that receives the transcoded audio and restarting the voice client and/or selecting a new voice client.

In some implementations, the action identification thresholds 247 may be dynamic. In this case, the thresholds that correspond to the various MOS improvement actions 230 may change depending on the situation. For example, if the MO device and MT device are communicating with their respective servers over different networks, then the thresholds may be higher than if the MO device and the MT device are communicating with the respective servers over the same network. As another example, the user of the MO device may provide an indication of the level of audio quality that the user expects during the audio communication. This indication may be an express indication directly received from the user or a determined expectation based on previous behavior of the user such as ending and restarting previous audio communications when transcoding was occurring and/or ending and restarting previous communication using a different application when transcoding was occurring. In this case, the action identification thresholds 247 may be higher than the default thresholds for other users.

In some implementations, the MOS improvement actions 230 may be dependent on the options available to the action identifier 112. For example, the MO device and the MT device may both have access to certain audio communication applications but not others. In this case, the MOS improvement actions 230 may only be able to select the available audio communication applications. As another example, the MOS improvement actions 230 may be selected by a user. The user may indicate which of the MOS improvement actions 230 are acceptable. The action identifier 112 may be unable to select the preapproved actions.

The one or more processors 210 may implement, through the execution of computer-executable instructions, the model trainer 270. The model trainer 270 may be configured to analyze the historical data 235 to generate the MOS prediction models 240 and/or the MOS prediction rules 245. The historical data 235 may include data related to previous voice communications. The data related to previous voice communications may include a codec used to initially encode the audio data, any codecs used to transcode the encoded audio data, data related to the transcoding, radio frequency information, RTP packet information, packet loss information, jitter information, RTCP information, band information, bandwidth utilized, capacity of the communication channel, a timestamp of the audio communication, a model of the MO device, a model of the MT device, a length of the communication, an application used to enable the audio communication, data identifying the network nodes used during the voice communication, a network that the MO device and the MT device are each using to communicate, whether the MO device or the MT device switched networks during the audio communication and to which network, and/or any other similar information. The historical data 235 may also include data indicating whether the audio communication included transcoded audio data and what portion of the audio data of the audio communication was transcoded. The historical data 235 may also include labels that specify the MOS for the audio communication.

The model trainer 270 may analyze the historical data 235 to identify patterns in the historical data 235. Based on the patterns, the model trainer 270 may generate a rule that specifies what patterns or characteristics of the audio communication data and other data should correspond to different MOSs. For example, the model trainer 270 may determine that audio data transcoded from AMR to EVS may have an MOS between 3.0 and 3.5. The model trainer 270 may determine that audio data encoded in EVS may have an MOS between 4.0 and 4.5. The model trainer may determine that audio data exchanged between device communicating using the same wireless network may have an MOS between 3.7 and 4.5.

Each of these identified patterns may correspond to a MOS prediction rule 245. Each MOS prediction rule 245 may or may not utilize all of the types of data included in the historical data 235. In some implementations, one or more MOS prediction rules 245 may be specified by a user. For example, a user may specify that the MOS is between 3.5 and 4.0 when the MO device and the MT device are both on a Wi-Fi connection and the audio communication application is a messaging application.

In some implementations, the MOS predictor 260 may use more than one MOS prediction rule 245 to determine the likely MOS of an audio communication. Some of the MOS prediction rules 245 may indicate ranges of MOSs. The MOS predictor 260 may use the overlapping portions of the ranges to identify a likely MOS. In some implementations, the ranges may not overlap. In this case, the MOS predictor 260 may determine an arithmetic mean, geometric mean, median, and/or mode of the ends and/or middle of the ranges to determine a likely MOS. In some implementations, the MOS predictor 260 may use the MOS prediction models 240 in the event that multiple MOS prediction rules 245 output conflicting likely MOSs.

The model trainer 270 may use the historical data 235 to train the MOS prediction models 240 using machine learning. The model trainer 270 may use random forest modeling, k-means cluster modeling, and/or any other similar modeling technique. The MOS prediction models 240 may be configured to receive data indicating a codec used to encode the audio data to be transmitted, data indicating any codecs used to transcode the audio data to be transmitted, data related to the transcoding, radio frequency information, RTP packet information, packet loss information, jitter information, RTCP information, a time of the audio communication, a model of the MO device, a model of the MT device, an application used to enable the audio communication, data identifying the network nodes used during the upcoming voice communication, a network that the MO device and the MT device are each using to communicate, whether the audio data to be transmitted will be transcoded, and/or any other similar information. The MOS prediction models 240 may output a likely MOS of the audio data to be transmitted between the MO device and the MT device. In some implementations, the MOS prediction models 240 may output a confidence score that indicates the accuracy of the likely MOS.

Different MOS prediction models 240 may be configured to receive different types of data. For example, an MOS prediction model 240 may be configured to receive data indicating a codec used to encode the audio data to be transmitted, data indicating any codecs used to transcode the audio data to be transmitted, data related to the transcoding, radio frequency information, and RTP packet information. Another MOS prediction model 240 may be configured to receive data indicating a codec used to encode the audio data to be transmitted, data indicating any codecs used to transcode the audio data to be transmitted, data related to the transcoding, a time of the audio communication, a model of the MO device, a model of the MT device, an application used to enable the audio communication, and data identifying the network nodes used during the upcoming voice communication.

The MOS predictor 260 may be configured to select the appropriate model based on the data accessible to the MOS predictor 260. Each of the MOS prediction models 240 may be configured to output a likely MOS, and optionally, a confidence score. In some implementations, if the confidence score is below a threshold, then the MOS predictor 260 may utilize an additional model based on the data accessible to the MOS predictor 260. In this case, the MOS predictor 260 may combine the multiple likely MOSs as weighted by the confidence scores to determine a likely MOS.

In some implementations, the model trainer 270 may be configured to update or retrain the MOS prediction models 240. Once the historical data 235 includes additional information, the model trainer 270 may retrain the MOS prediction models 240 using machine learning. In some implementations, the historical data 235 may include data that the MOS predictor 260 previously analyzed and determined a likely MOS. The likely MOS may be updated with an actual MOS that may be determined by a user and/or by a process that analyzes the outputted audio data and assigns an MOS. The previously analyzed data and the actual MOS may be added to the historical data 235. The model trainer 270 may retrain the MOS prediction models 240 using the previous historical data 235 and the previously analyzed data and the actual MOS. This feedback loop may continue as the historical data 235 includes new data. The model trainer 270 may continue to update and improve the accuracy of the MOS prediction models 240.

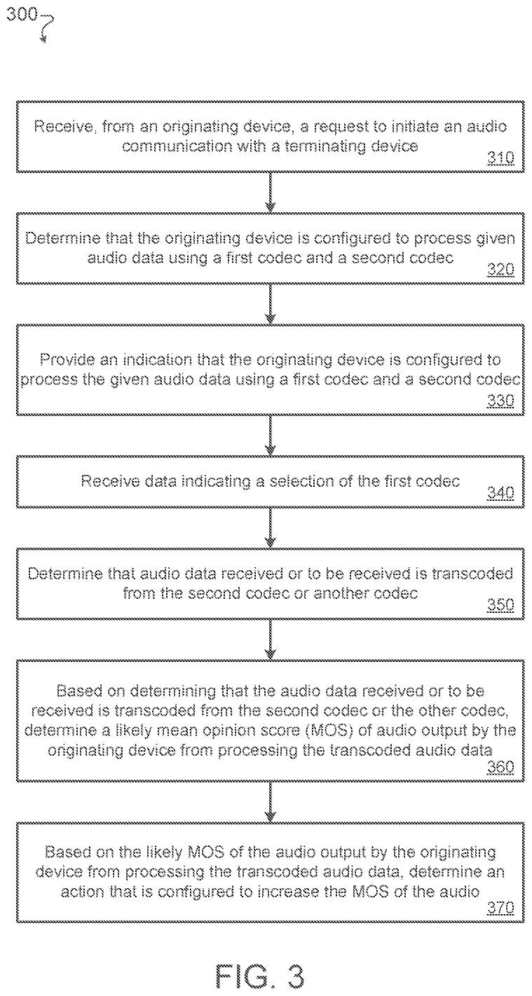

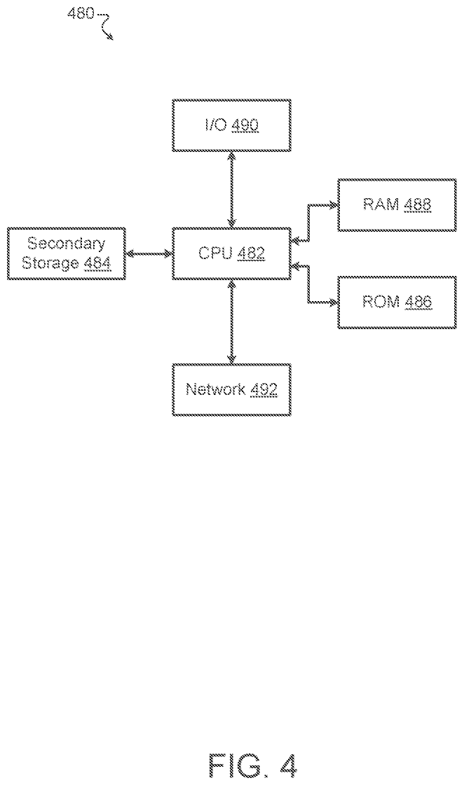

FIG. 3 is a flowchart of an example process 300 for determining when an audio communication includes transcoded audio data and, if necessary, perform an action to improve audio quality. In general, the process 300 initiates an audio communication between an MO device and an MT device. The process 300 determines a codec to use for the audio communication. Based on the process 300 determining whether the audio data encoded using the codec is transcoded, the process 300 may take an action to improve the quality of the outputted audio. The process 300 will be described as being performed by the MO server 114 and will include references to other components in FIG. 1. In some implementations, the process 300 may be performed by the server 200 of FIG. 2 and/or the system 480 of FIG. 4 discussed below. The process 300 may be performed by a single computing device or split across multiple computing devices that may include virtual devices.

The voice application 102 receives, from an originating device 126, a request to initiate an audio communication with a terminating device 150 (310). In some implementations, the audio communication is a voice communication between a user 128 of the originating device 126 and a user 152 of the terminating device 150. For example, the voice communication may be a phone call using a phone application of a mobile phone or a voice communication using a messaging application. The voice communication may move through the network on voice channels and/or data channels.

The voice application 102 determines that the originating device 126 is configured to process given audio data using a first codec and a second codec (320). In some implementations, the voice application 102 may query the originating device 126 for the available codecs. The voice application 102 provides, for output, an indication that the originating device is configured to process the given audio data using a first codec and a second codec (330). In some implementations, the voice application 120 generates a SIP invite that includes a field that identifies the available codecs. The voice application 120 may populate the field with data identifying the first codec and the second codec. For example, the SIP invite 116 may indicate that the originating device 126 supports the EVS codec, the AMR-WB codec, and the AMR codec.

In some implementations, the voice application 102 may receive a first SIP SDP message from the terminating device requesting the codecs that the originating device is configured to utilize. In some implementations, the voice application 102 may output to the terminating device a second SIP SDP message indicating the codecs that the originating device is configured to utilize. The second SIP SDP message may be in response to the first SIP SDP message or outputted independently in the case where there is not first SIP SDP message.

The voice application 102 receives data indicating a selection of the first codec (340). In some implementations, the terminating device 150 and/or the terminating server 124 may select a codec from the codecs identified in the SIP invite 116. The terminating server 124 may generate a SIP 180 ringing 120 that includes the selection of the first codec. In some implementations, the voice application 102 receives data indicating a selection of the first codec via a third SIP SDP message. The third SIP SDP message may be independent of the first or second SIP SDP messages being used in the communications. In some implementations, the voice application 102 receives data indicating a selection of the first codec via a third SIP SDP message even with different types of messages are utilized instead of the first and/or SIP SDP messages.

The voice application 102 determines that audio data received or to be received is transcoded from the second codec or another codec (350). In some implementations, the voice application 102 queries the terminating server 124 to request information on whether the audio data received or to be received is transcoded. In this case, the voice application 102 may generate a SIP SDP negotiation message to transmit to the terminating server 124 to request information on whether the audio data received or to be received is transcoded. In some implementations, terminating server 124 may include a transcoding flag in the SIP 180 ringing 120 that indicates whether the audio data received or to be received is transcoded.

Based on determining that the audio data received or to be received is transcoded from the second codec or the other codec, the voice application 102 determines a likely mean opinion score (MOS) of audio output by the originating device 126 from processing the transcoded audio data (360). In some implementations, the voice application 102 provides various characteristics of the voice communication, the devices involved in the voice communication, the networks involved in the voice communication, the context of the voice communication, data indicating the codecs, data indicating whether the audio data is or will be transcoded, and/or any other similar characteristic or parameters of the voice communication as an input to a machine learning trained model. The model may be configured output the likely MOS of the audio output by the originating device 126.

In some implementations, the voice application 102 or another application may train the model using machine learning and historical data. The historical data may include data from previous voice communications. The historical data may include various characteristics of the previous voice communications, the devices involved in the previous voice communications, the networks involved in the previous voice communications, the context of the previous voice communications, data indicating the codecs, data indicating whether the audio data was transcoded, and/or any other similar characteristic or parameters of the previous voice communications. The historical data may also include MOSs of the previous voice communications.

Based on the likely MOS of the audio output by the originating device from processing the transcoded audio data, the voice application 102 determines an action that is configured to increase the MOS of the audio (370). In some implementations, the voice application 120 may compare the likely MOS to a MOS threshold. If the likely MOS does not satisfy the MOS threshold, then the voice application 102 may determine the action. In some implementations, the voice application may automatically implement the action and/or provide instructions for the implementation of the action.

In some implementations, the voice application 102 may receive an actual MOS of the audio data of the audio communication. The voice application 102 may update, or retrain, the model with the actual MOS of the audio data and the characteristics of the voice communication, the devices involved in the voice communication, the networks involved in the voice communication, the context of the voice communication, data indicating the codecs, data indicating whether the audio data was transcoded, any data provided as input to the model, and the actual MOS. This feedback mechanism may continue as additional data is generated from additional communications.

FIG. 4 illustrates an example computer system 480 suitable for implementing one or more implementations disclosed herein. The computer system 480 includes a processor 482 (which may be referred to as a central processor unit or CPU) that is in communication with memory devices including secondary storage 484, read only memory (ROM) 486, random access memory (RAM) 488, input/output (I/O) devices 490, and network connectivity devices 492. The processor 482 may be implemented as one or more CPU chips.

It is understood that by programming and/or loading executable instructions onto the computer system 480, at least one of the CPU 482, the RAM 488, and the ROM 486 are changed, transforming the computer system 480 in part into a particular machine or apparatus having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

Additionally, after the system 480 is turned on or booted, the CPU 482 may execute a computer program or application. For example, the CPU 482 may execute software or firmware stored in the ROM 486 or stored in the RAM 488. In some cases, on boot and/or when the application is initiated, the CPU 482 may copy the application or portions of the application from the secondary storage 484 to the RAM 488 or to memory space within the CPU 482 itself, and the CPU 482 may then execute instructions that the application is comprised of. In some cases, the CPU 482 may copy the application or portions of the application from memory accessed via the network connectivity devices 492 or via the I/O devices 490 to the RAM 488 or to memory space within the CPU 482, and the CPU 482 may then execute instructions that the application is comprised of. During execution, an application may load instructions into the CPU 482, for example load some of the instructions of the application into a cache of the CPU 482. In some contexts, an application that is executed may be said to configure the CPU 482 to do something, e.g., to configure the CPU 482 to perform the function or functions promoted by the subject application. When the CPU 482 is configured in this way by the application, the CPU 482 becomes a specific purpose computer or a specific purpose machine.

The secondary storage 484 is typically comprised of one or more disk drives or tape drives and is used for non-volatile storage of data and as an over-flow data storage device if RAM 488 is not large enough to hold all working data. Secondary storage 484 may be used to store programs which are loaded into RAM 488 when such programs are selected for execution. The ROM 486 is used to store instructions and perhaps data which are read during program execution. ROM 486 is a non-volatile memory device which typically has a small memory capacity relative to the larger memory capacity of secondary storage 484. The RAM 488 is used to store volatile data and perhaps to store instructions. Access to both ROM 486 and RAM 488 is typically faster than to secondary storage 484. The secondary storage 484, the RAM 488, and/or the ROM 486 may be referred to in some contexts as computer readable storage media and/or non-transitory computer readable media.

I/O devices 490 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 492 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards, and/or other well-known network devices. The network connectivity devices 492 may provide wired communication links and/or wireless communication links (e.g., a first network connectivity device 492 may provide a wired communication link and a second network connectivity device 492 may provide a wireless communication link). Wired communication links may be provided in accordance with Ethernet (IEEE 802.3), Internet protocol (IP), time division multiplex (TDM), data over cable service interface specification (DOCSIS), wavelength division multiplexing (WDM), and/or the like. In some implementations, the radio transceiver cards may provide wireless communication links using protocols such as code division multiple access (CDMA), global system for mobile communications (GSM), long-term evolution (LTE), WiFi (IEEE 802.11), Bluetooth, Zigbee, narrowband Internet of things (NB IoT), near field communications (NFC) and radio frequency identity (RFID). The radio transceiver cards may promote radio communications using 5G, 5G New Radio, or 5G LTE radio communication protocols. These network connectivity devices 492 may enable the processor 482 to communicate with the Internet or one or more intranets. With such a network connection, it is contemplated that the processor 482 might receive information from the network, or might output information to the network in the course of performing the above-described method steps. Such information, which is often represented as a sequence of instructions to be executed using processor 482, may be received from and outputted to the network, for example, in the form of a computer data signal embodied in a carrier wave.

Such information, which may include data or instructions to be executed using processor 482 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods well-known to one skilled in the art. The baseband signal and/or signal embedded in the carrier wave may be referred to in some contexts as a transitory signal.

The processor 482 executes instructions, codes, computer programs, scripts which it accesses from hard disk, floppy disk, optical disk (these various disk-based systems may all be considered secondary storage 484), flash drive, ROM 486, RAM 488, or the network connectivity devices 492. While only one processor 482 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 484, for example, hard drives, floppy disks, optical disks, and/or other device, the ROM 486, and/or the RAM 488 may be referred to in some contexts as non-transitory instructions and/or non-transitory information.

In some implementations, the computer system 480 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In some implementations, virtualization software may be employed by the computer system 480 to provide the functionality of a number of servers that is not directly bound to the number of computers in the computer system 480. For example, virtualization software may provide twenty virtual servers on four physical computers. In some implementations, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third-party provider. Some cloud computing environments may comprise cloud computing resources owned and operated by the enterprise as well as cloud computing resources hired and/or leased from a third-party provider.

In some implementations, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid state memory chip, for example analog magnetic tape, compact disk read only memory (CD-ROM) disks, floppy disks, jump drives, digital cards, multimedia cards, and others. The computer program product may be suitable for loading, by the computer system 480, at least portions of the contents of the computer program product to the secondary storage 484, to the ROM 486, to the RAM 488, and/or to other non-volatile memory and volatile memory of the computer system 480. The processor 482 may process the executable instructions and/or data structures in part by directly accessing the computer program product, for example by reading from a CD-ROM disk inserted into a disk drive peripheral of the computer system 480. Alternatively, the processor 482 may process the executable instructions and/or data structures by remotely accessing the computer program product, for example by downloading the executable instructions and/or data structures from a remote server through the network connectivity devices 492. The computer program product may comprise instructions that promote the loading and/or copying of data, data structures, files, and/or executable instructions to the secondary storage 484, to the ROM 486, to the RAM 488, and/or to other non-volatile memory and volatile memory of the computer system 480.

In some contexts, the secondary storage 484, the ROM 486, and the RAM 488 may be referred to as a non-transitory computer readable medium or a computer readable storage media. A dynamic RAM implementation of the RAM 488, likewise, may be referred to as a non-transitory computer readable medium in that while the dynamic RAM receives electrical power and is operated in accordance with its design, for example during a period of time during which the computer system 480 is turned on and operational, the dynamic RAM stores information that is written to it. Similarly, the processor 482 may comprise an internal RAM, an internal ROM, a cache memory, and/or other internal non-transitory storage blocks, sections, or components that may be referred to in some contexts as non-transitory computer readable media or computer readable storage media.

While several implementations have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various implementations as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A computer-implemented method comprising:
receiving, by an application and from an originating device, a request to initiate an audio communication with a terminating device;
determining, by the application, that the originating device is configured to process given audio data using a first codec and a second codec;
providing, for output by the application via a first session initiation protocol (SIP) session description protocol (SDP) message, an indication that the originating device is configured to process the given audio data using a first codec and a second codec;
receiving, by the application via a second SIP SDP message, data indicating a selection of the first codec;
determining, by the application, that audio data received or to be received is transcoded from the second codec or another codec;
based on determining that the audio data received or to be received is transcoded from the second codec or the other codec, determining, by the application, a likely mean opinion score (MOS) of audio output by the originating device from processing the transcoded audio data; and
based on the likely MOS of the audio output by the originating device from processing the transcoded audio data, determining, by the application, an action that is configured to increase the MOS of the audio.

2. The method of claim 1, wherein determining the likely MOS of the audio output by the originating device from processing the transcoded audio data comprises:
determining, by the application, characteristics of the first codec, characteristics of the second codec or the other codec, characteristics of the originating device, and characteristics of the terminating device;
providing, by the application, the characteristics of the first codec, the characteristics of the second codec or the other codec, the characteristics of the originating device, and the characteristics of the terminating device as an input to a model that is configured to output the likely MOS of the audio output by the originating device from processing the transcoded audio data; and
receiving, by the application and from the model, the likely MOS of the audio output by the originating device from processing the transcoded audio data.

3. The method of claim 2, comprising:
accessing, by the application, historical data that includes previous characteristics of a previous first codec, previous characteristics of a previous second codec or a previous other codec, previous characteristics of a previous originating device, previous characteristics of a previous terminating device, and a previous MOS of previous audio; and
training, by the application, using machine learning, and using the historical data, the model.

4. The method of claim 3, comprising:
receiving, by the application and from a user of the originating device, data indicating a quality of the audio output by the originating device; and
updating, by the application and using machine learning, the model using the characteristics of the first codec, the characteristics of the second codec or the other codec, the characteristics of the originating device, the characteristics of the terminating device, and the data indicating the quality of the audio output by the originating device.

5. The method of claim 1, comprising:
comparing the MOS of the audio to a threshold MOS; and
determining that the MOS of the audio does not satisfy the threshold MOS,
wherein determining the action that is configured to increase the MOS of the audio is further based on determining that the MOS of the audio does not satisfy the threshold MOS.

6. The method of claim 1, wherein providing the indication that the originating device is configured to process the given audio data using the first codec and the second codec comprises:
providing a session initiation protocol (SIP) invite that includes the indication that the originating device is configured to process the given audio data using the first codec and the second codec.

7. The method of claim 1, wherein determining that the audio data received or to be received is transcoded from the second codec or the other codec comprises:
determining, by the application, codec information of the terminating device via a session initiation protocol, session description protocol negotiation message.

8. The method of claim 1, wherein determining that the audio data received or to be received is transcoded from the second codec or the other codec comprises:
determining that the audio data received or to be received includes data indicating that the audio data is transcoded.

9. The method of claim 1, wherein the audio communication is a voice communication between a first user of the originating device and a second user of the terminating device.

10. The method of claim 1, comprising:
performing, by the application, the action that is configured to increase the MOS of the audio.

11. A system, comprising:
one or more processors; and
a memory including a plurality of computer-executable components that are executable by the one or more processors to perform a plurality of acts, the plurality of acts comprising:
receiving, from an originating device, a request to initiate an audio communication with a terminating device;
determining that the originating device is configured to process given audio data using a first codec and a second codec;
providing, for output, an indication that the originating device is configured to process the given audio data using a first codec and a second codec;
receiving data indicating a selection of the first codec;
providing, for output, a first session initiation protocol, session description protocol negotiation message;
in response to providing, for output, the session initiation protocol, session description protocol negotiation message, receiving data indicating the audio data received or to be received is transcoded from the second codec or another codec;
based on receiving the data indicating that the audio data received or to be received is transcoded from the second codec or another codec, determining a likely mean opinion score (MOS) of audio output by the originating device from processing the transcoded audio data; and
based on the likely MOS of the audio output by the originating device from processing the transcoded audio data, determining an action that is configured to increase the MOS of the audio.

12. The system of claim 11, wherein determining the likely MOS of the audio output by the originating device from processing the transcoded audio data comprises:
determining, by the application, characteristics of the first codec, characteristics of the second codec or the other codec, characteristics of the originating device, and characteristics of the terminating device;
providing, by the application, the characteristics of the first codec, the characteristics of the second codec or the other codec, the characteristics of the originating device, and the characteristics of the terminating device as an input to a model that is configured to output the likely MOS of the audio output by the originating device from processing the transcoded audio data; and
receiving, by the application and from the model, the likely MOS of the audio output by the originating device from processing the transcoded audio data.

13. The system of claim 12, wherein the plurality of acts comprise:
accessing, by the application, historical data that includes previous characteristics of a previous first codec, previous characteristics of a previous second codec or a previous other codec, previous characteristics of a previous originating device, previous characteristics of a previous terminating device, and a previous MOS of previous audio; and
training, by the application, using machine learning, and using the historical data, the model.

14. The system of claim 13, wherein the plurality of acts comprise:
receiving, by the application and from a user of the originating device, data indicating a quality of the audio output by the originating device; and
updating, by the application and using machine learning, the model using the characteristics of the first codec, the characteristics of the second codec or the other codec, the characteristics of the originating device, the characteristics of the terminating device, and the data indicating the quality of the audio output by the originating device.

15. The system of claim 11, wherein the plurality of acts comprise:
comparing the MOS of the audio to a threshold MOS; and
determining that the MOS of the audio does not satisfy the threshold MOS,
wherein determining the action that is configured to increase the MOS of the audio is further based on determining that the MOS of the audio does not satisfy the threshold MOS.

16. The system of claim 11, wherein providing the indication that the originating device is configured to process the given audio data using the first codec and the second codec comprises:
providing a session initiation protocol (SIP) invite that includes the indication that the originating device is configured to process the given audio data using the first codec and the second codec.

17. The system of claim 11, wherein the audio communication is a voice communication between a first user of the originating device and a second user of the terminating device.

18. The system of claim 11, wherein the plurality of acts comprise:
performing, by the application, the action that is configured to increase the MOS of the audio.

19. One or more non-transitory computer-readable media storing computer-executable instructions that upon execution cause one or more computers to perform acts comprising:
receiving, from an originating device, a request to initiate an audio communication with a terminating device;
determining that the originating device is configured to process given audio data using a first codec and a second codec;
providing, for output, an indication that the originating device is configured to process the given audio data using a first codec and a second codec;
receiving data indicating a selection of the first codec;
determining that the data indicating the selection of the first codec includes a flag indicating that audio data received or to be received is transcoded from the second codec or another codec;
based the data indicating the selection of the first codec includes the flag indicating that audio data received or to be received is transcoded from the second codec or the other codec, determining that audio data received or to be received is transcoded from the second codec or the other codec;
based on determining that the audio data received or to be received is transcoded from the second codec or the other codec, determining a likely mean opinion score (MOS) of audio output by the originating device from processing the transcoded audio data; and
based on the likely MOS of the audio output by the originating device from processing the transcoded audio data, determining an action that is configured to increase the MOS of the audio.

20. The media of claim 19, wherein determining the likely MOS of the audio output by the originating device from processing the transcoded audio data comprises:
determining, by the application, characteristics of the first codec, characteristics of the second codec or the other codec, characteristics of the originating device, and characteristics of the terminating device;
providing, by the application, the characteristics of the first codec, the characteristics of the second codec or the other codec, the characteristics of the originating device, and the characteristics of the terminating device as an input to a model that is configured to output the likely MOS of the audio output by the originating device from processing the transcoded audio data; and
receiving, by the application and from the model, the likely MOS of the audio output by the originating device from processing the transcoded audio data.
